(19) United States
(12) Patent Application Publication
(10) Pub. No.: US 2017/0354971 A1
(43) Pub. Date: Dec. 14, 2017

(54) FLOW CHANNEL DEVICE

(71) Applicant: SUMITOMO BAKELITE CO., LTD., Tokyo (JP)

(72) Inventor: Hirohito Taniguchi, Tokyo (JP)

(73) Assignee: SUMITOMO BAKELITE CO., LTD., Tokyo (JP)

(21) Appl. No.: 15/610,982

(22) Filed: Jun. 1, 2017

(30) Foreign Application Priority Data
Jun. 8, 2016 (JP) 2016-114704

(51) Int. Cl. B01L 3/00; B32B 37/18; B32B 7/12; B01F 13/00; B32B 38/00; B32B 37/12; B32B 27/08

(52) U.S. Cl. CPC B01L 3/502707; B32B 37/12; B32B 37/182; B32B 27/08; B01F 13/0059; B32B 38/0004; B32B 7/12; B01L 2300/12; B01L 2200/12

(57) ABSTRACT

An object of the present invention is to provide a flow channel device which hardly generates air bubbles within a flow channel and includes: a base material having a groove; and a coating material which is integrated with the base material so as to cover the groove, in which the difference (θ1−θ2) between a contact angle (θ1) of a portion facing the groove in the coating material with respect to pure water and a contact angle (θ2) of the groove portion of the base material with respect to the pure water is −30° to 30°.

### TECHNICAL FIELD OF THE INVENTION

The present invention relates to a flow channel device.

### RELATED ART

A technique is known in which a flow channel is provided on a substrate and biochemical measurement or chemical synthesis is performed by making a fluid flow into the flow channel. Particularly, a microanalysis device, a microreaction device, or the like produced using a micro-machining technique is preferably used from the viewpoints of miniaturization, portability, reduction in the amount of a specimen, reduction in the amount of a reagent, reduction in the amount of a waste solution, rapidness, and the like. In some cases, the flow channel device used for the purpose is produced, for example, by joining a base material (substrate 3) having a groove (flow channel groove 30) to a coating material (film 4) which covers the groove as disclosed in PCT International Publication No. WO2012/060186 (Patent Document 1).

However, according to studies of the present inventors, it has become clear that, in some cases, air bubbles are generated within a flow channel depending on the properties of a coating material when allowing a fluid such as a specimen solution or a reagent solution to flow into the flow channel in a case of using the flow channel device produced as described above. In the flow channel device, if air bubbles are generated within the flow channel, there is a possibility that an adverse effect may be caused to various types of treatments, reactions, and analyses. Particularly, even if air bubbles generated are small since the entire system is very small in a micro-flow channel device, the effect greatly appears. In addition, there is a possibility that a sufficient pretreatment may not be performed in the micro-treatment device, reactivity may be reduced in a micro-reaction device, or the detection accuracy may be reduced in the micro-analysis device. For this reason, it is necessary to take measures so as to avoid the generation of air bubbles within the flow channel as much as possible.

### PRIOR ART DOCUMENT

### Patent Document

[Patent Document 1] PCT International Publication No. WO2012/060186

### DISCLOSURE OF THE INVENTION

### Problems to be Solved by the Invention

It is desired to provide a flow channel device which hardly generates air bubbles within a flow channel.

### Means for Solving the Problem

The present inventors have conducted extensive studies, and as a result, they have found that, in a flow channel device which is produced by joining a base material having a groove to a coating material which covers the groove, wettability of a groove portion of the base material or a portion facing the groove in the coating material has a great influence on generation of air bubbles within a flow channel. Moreover, they have found a new finding that it is possible to suppress the generation of air bubbles within the flow channel by setting the difference between a contact angle of the portion facing the groove in the coating material and a contact angle of the portion of the groove of the base material to be within a predetermined range in relation to the properties of a liquid sample flowing into the flow channel. The present invention has been made based on the finding and provides the following flow channel device.

A flow channel device according to the present invention includes: a base material having a groove; and a coating material which is integrated with the base material so as to cover the groove, in which the difference (θ1−θ2) between a contact angle (θ1) of a portion facing the groove in the coating material with respect to pure water and a contact angle (θ2) of the groove portion of the base material with respect to the pure water is −30° to 30°.

The flow channel device of the present invention hardly generates air bubbles within a flow channel divided by the groove.

In the above-described flow channel device, it is preferable that the coating material includes a fluid-impermeable film material and an adhesive layer which is laminated on the fluid-impermeable film material, and the base material and the fluid-impermeable film material are integrated through the adhesive layer.

According to the above-described flow channel device, it is possible to simply integrate the base material and the film material by bonding the base material to the film material through the adhesive layer. Accordingly, it is possible to improve productivity and to achieve cost reduction.

In addition, it is easy to maintain the shape of the film material due to reduced influence of heat unlike a case where, for example, a base material and a film material are subjected to thermal pressure bonding, and therefore, deformation of a flow channel is small. Accordingly, it is possible to form the flow channel with high shape accuracy and to easily uniformize flow of a fluid within the flow channel.

In the above-described flow channel device, it is preferable that the adhesive layer has pressure-sensitive adhesive properties.

In the present specification, the pressure-sensitive adhesive properties refer to a type of joining. In addition, the adhesion means joining performed by only adding a pressure at normal temperature for a short period of time without using water, a solvent, heat, and the like.

According to the above-described flow channel device, it is possible to sufficiently secure the adhesive strength between the base material and the film material using the adhesive layer having pressure-sensitive adhesive properties.

In addition, it is possible to integrate the base material and the film material for a short period of time under a normal temperature condition and to further achieve cost reduction by further improving the productivity.

In the above-described flow channel device, it is preferable that the adhesive layer contains a (meth)acrylic resin.

According to the above-described flow channel device, a flow channel device excellent in heat resistance is obtained by employing a structure in which the base material and the film material are integrated through the adhesive layer.

In addition, it is possible to achieve cost reduction from the viewpoint that the adhesive layer containing a (meth)acrylic resin is comparatively easily available at a low cost.

In the above-described flow channel device, it is preferable that the coating material is formed of a fluid-impermeable film material of a single layer, and the base material and the fluid-impermeable film material are integrated.

According to the above-described flow channel device, it is possible to form the inner surface of the entirety of the flow channel with the same material by forming the base material and the film material with the same or similar material, and therefore, it is possible to easily uniformize flow of a fluid within the flow channel.

In the above-described flow channel device, it is preferable that the base material contains at least one selected from the group consisting of a (meth)acrylic-based resin, a styrene-based resin, a polycarbonate-based resin, and a polyolefin-based resin.

According to the above-described flow channel device, it is possible to form the base material having the groove with high shape accuracy and favorable moldability. Accordingly, it is possible to form the flow channel with high shape accuracy and to more easily uniformize the flow of a fluid within the flow channel.

Further characteristics and advantages of the present invention will become clearer through the description of the following exemplary and non-restrictive embodiments to be described below with reference to drawings.

### BRIEF DESCRIPTION OF THE DRAWINGS

FIG. 1 is a perspective view of a flow channel device according to an embodiment.

FIG. 2 is a cross-sectional view of a flow channel device of a first embodiment.

FIG. 3 is a cross-sectional view of a flow channel device of a second embodiment.

### EMBODIMENTS OF THE INVENTION

### First Embodiment

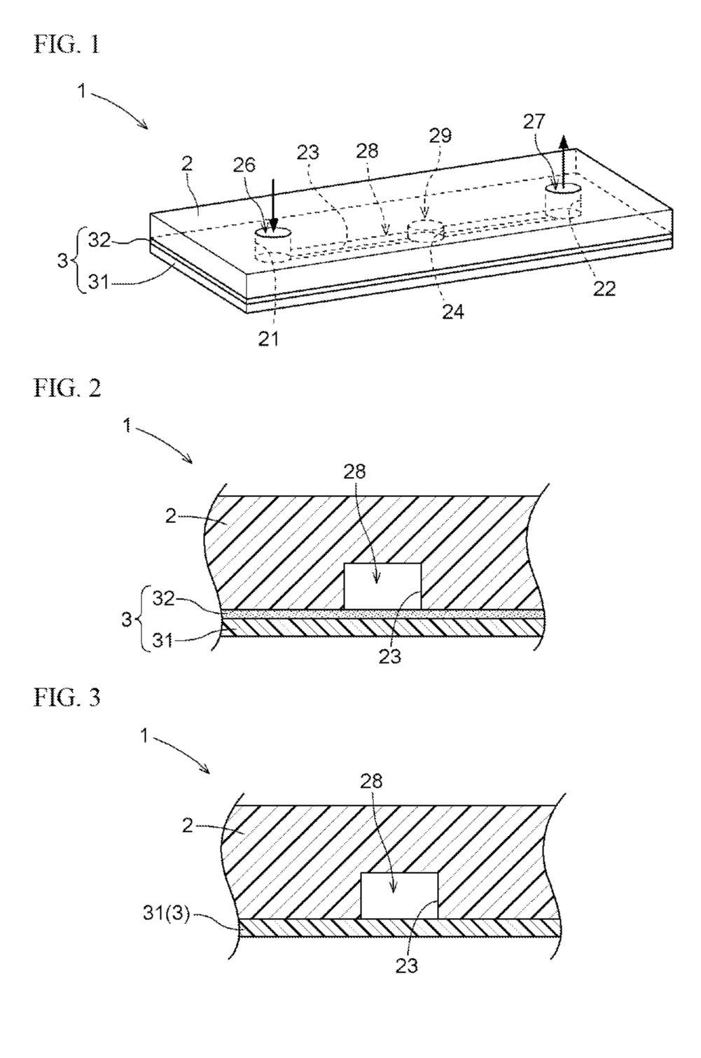

An embodiment of a flow channel device of the present invention will be described with reference to drawings. As shown in FIGS. 1 and 2, a flow channel device 1 includes a base material 2 having a groove 23 and a coating material 3 which is integrated with the base material 2 so as to cover the groove 23. A flow channel 28 is formed between the base material 2 and the coating material 3. The flow channel 28 is divided and formed by the inner surface of the groove 23 in the base material 2 and the inner surface of a portion facing to the groove 23 in the coating material 3.

The base material 2 is formed, for example, into a plate shape with several cm square having a thickness of about 1 mm to 5 mm. In the present embodiment, a first through-hole 21, a second through-hole 22, the groove 23, and a concavity 24 are formed in the base material 2. The first through-hole 21 and the second through-hole 22 are formed so as to penetrate through the base material 2 in a thickness direction. The groove 23 is provided on at least one principal surface of the base material 2 so as to connect the first through-hole 21 to the second through-hole 22. In the example of this drawing, the groove 23 is formed as a concave groove having a pair of side surfaces facing to each other and a bottom surface connecting the both side surfaces, on one principal surface of the base material 2. The concavity 24 is formed at any position (for example, a central portion) of the groove 23 so as to be recessed in a concave shape from the principal surface on which the groove 23 is formed.

The groove 23 formed in the base material 2 is formed to have a width, for example, of 1 μm to 2 mm. The width of the groove 23 is preferably 5 μm to 800 μm and more preferably 5 μm to 500 μm.

In addition, the groove 23 is formed to have a depth, for example, of 1 μm to 1 mm. The depth of the groove 23 is preferably 5 μm to 800 μm and more preferably 5 μm to 500 μm.

That is, the flow channel device 1 of the present embodiment is formed as a micro-flow channel device having the micron-order groove 23 (flow channel 28). The length of the groove 23 can be set, for example, to 1 mm to 100 mm.

The base material 2 can be produced using a resin composition for forming a base material which has fluid impermeability so as not to allow a fluid to transmit therethrough. Resins contained in the resin composition for forming a base material are not particularly limited, and examples thereof include one or more resins selected from the group consisting of a (meth)acrylic resin, a styrene-based resin, a polycarbonate-based resin, a polyolefin-based resin, polyvinyl chloride, polyester, polyvinyl acetate, a vinyl-acetate copolymer, nylon, polymethylpentene, a silicon resin, an amino resin, polysulfone, polyether sulfone, polyether imide, a fluororesin, and polyimide. Among them, the resin composition for forming a base material preferably contains one or more resins selected from the group consisting of a (meth)acrylic resin, a styrene-based resin, a polycarbonate-based resin, and a polyolefin-based resin from the viewpoint of improving the shape accuracy and the moldability.

Examples of the (meth)acrylic resin include: polyacrylic acid; polymethacrylic acid; polyacrylic esters such as polymethyl acrylate, polyethyl acrylate, polybutyl acrylate, and poly(2-ethylhexyl acrylate); polymethacrylic esters such as polymethyl methacrylate, polyethyl methacrylate, and polybutyl methacrylate; polyacrylonitrile, polymethacrylonitrile; and polyacrylamide. The (meth)acrylic resin preferably contains at least one structural unit among a structural unit derived from methyl acrylate and a structural unit derived from methyl methacrylate from the viewpoint of improving moldability.

The (meth)acrylic resin can be obtained through polymerization by adding a polymerization initiator to a mixture of monomers. For example, organic peroxide-based polymerization initiators such as benzoyl peroxide, lauroyl peroxide, t-butyl peroxyisobutyrate, t-butyl peroxy-2-ethylhexanoate, t-butyl peroxyneodecanoate, t-hexyl peroxypivalate, diisopropyl peroxydicarbonate, bis(4-t-butylcyclohexyl)peroxydicarbonate; and azo-based polymerization initiators such as 2,2′-azobisisobutyronitrile, 2,2′-azobis(2,4-dimethylvaleronitrile), and 2,2′-azobis(4-methoxy-2,4-dimethylvaleronitrile) can be used as the polymerization initiator. The resin composition for forming a base material may contain two or more (meth)acrylic resins having different structures.

Examples of the styrene-based resin include atactic polystyrene, isotactic polystyrene, high impact resistant polystyrene (HIPS), an acrylonitrile-butadiene-styrene (ABS) copolymer, an acrylonitrile-styrene (AS) copolymer, a styrene-acrylic acid copolymer, a styrene-acrylic acid ester copolymer, a styrene-methacrylic acid copolymer, a styrene-methacrylic ester copolymer, a styrene-maleic acid copolymer, and a styrene-fumaric acid copolymer.

Examples of the polycarbonate-based resin include polyethylene carbonate, polypropylene carbonate, polybutylene carbonate, polyisobutylene carbonate, polyhexene carbonate, polycyclobutylene carbonate, polycyclopentene carbonate, polycyclohexene carbonate, poly(methylcyclohexene carbonate), poly(vinyl cyclohexene carbonate), polydihydronaphthalene carbonate, polyhexahydrostyrene carbonate, polycyclohexane propylene carbonate, polystyrene carbonate, poly(3-phenyl propylene carbonate), poly(3-trimethylsilyloxypropylene carbonate), poly(3-methacryloyloxypropylene carbonate), polyperfluoropropylene carbonate, polynorbornene carbonate, and poly(1,3-cyclohexylene carbonate).

Examples of the polyolefin-based resin include linear high density polyethylene, linear low density polyethylene, high-pressure low-density polyethylene, isotactic polypropylene, syndiotactic polypropylene, block polypropylene, random polypropylene, polybutene, 1,2-polybutadiene, 4-methylpentene, and cyclic polyolefin (cycloolefin resin), and copolymers thereof (for example, ethylene-methyl methacrylate copolymer).

The resin composition for forming a base material may further contain additives such as a pigment, a dye, an oxidation inhibitor, and a flame retardant in addition to the above-described resin components. In addition, other components may be mixed with the resin composition for forming a base material as necessary.

The base material 2 may be produced using the above-described resin composition for forming a base material. In addition, a commercially available plate-shaped resin material may be used as it is or by being processed, as the base material. In addition, the base material 2 is not limited to be formed of a resin, and may be formed, for example, of glass or silicon.

As shown in FIGS. 1 and 2, the coating material 3 integrated with the base material 2 in the flow channel device of the present embodiment includes a film material 31 and an adhesive layer 32 laminated on the film material 31. In the present embodiment, the base material 2 and the film material 31 are integrated through the adhesive layer 32.

The film material 31 has fluid impermeability. The thickness of the film material 31 can be set, for example, to 50 μm to 300 μm. When the thickness is set to such a range, workability is improved and the film material 31 can be highly accurately integrated with the base material 2.

The thickness of the film material 31 is preferably greater than or equal to 60 μm. In addition, the thickness of the film material 31 is preferably less than or equal to 200 μm. When such a thin film material 31 is used, it is possible to control, for example, the temperature within the flow channel 28 using the film material 31. In addition, in a case of using, for example, the flow channel device 1 as a microanalysis device, it is possible to reduce background noise caused by auto-fluorescence.

The film material 31 can be produced using, for example, a resin composition for forming a film material. Resins contained in the resin composition for forming a film material are not particularly limited, but examples thereof include one or more resins selected from the group consisting of a (meth)acrylic resin, polystyrene, polyethylene, polypropylene, polyvinyl chloride, polycarbonate, polyester, polyvinyl acetate, a vinyl-acetate copolymer, a styrene-methyl methacrylate copolymer, an acrylonitrile-styrene copolymer, an acrylonitrile-butadiene-styrene copolymer, nylon, polymethylpentene, a silicon resin, an amino resin, polysulfone, polyether sulfone, polyether imide, a fluororesin, and polyimide. Among them, the resin composition for forming a film material preferably contains a (meth)acrylic resin from the viewpoint of improving moldability.

It is possible to use the same (meth)acrylic resin as the (meth)acrylic resin contained in the above-described resin composition for forming a base material. The (meth)acrylic resin contained in the resin composition for forming a film material preferably contains at least one of a structural unit derived from C₃-C₆ acrylic acid alkyl ester and a structural unit derived from C₃-C₆ methacrylic acid alkyl ester. Here, the “C₃-C₆ alkyl ester” means ester containing an alkyl group derived from alcohol having 3 to 6 carbon atoms. The (meth)acrylic resin preferably contains at least one of a structural unit derived from butyl acrylate and a structural unit derived from butyl methacrylate from the viewpoint of further improving moldability.

In addition, the resin composition for forming a film material may contain two or more (meth)acrylic resins having different structures. For example, the resin composition for forming a film material may further contain at least one of a structural unit derived from methyl acrylate and a structural unit derived from methyl methacrylate in addition to at least one of the above-described structural unit derived from C₃-C₆ acrylic acid alkyl ester and the above-described structural unit derived from C₃-C₆ methacrylic acid alkyl ester.

The resin composition for forming a film material may further contain additives such as a pigment, a dye, an oxidation inhibitor, an antistatic agent, and a flame retardant in addition to the above-described resin components. In addition, other components may be mixed with the resin composition for forming a film material as necessary.

The film material 31 may be produced using the above-described resin composition for forming a film material. In addition, a commercially available resin film material may be used as it is or by being processed, as the film material.

The thickness of the adhesive layer 32 laminated on the film material 31 can be set, for example, to 1 μm to 20 μm. When the thickness is set to such a range, it is possible to suitably maintain the shape of the flow channel 28 while bonding the base material 2 to the film material 31 with sufficient adhesive strength. The thickness of the adhesive layer 32 is preferably set to greater than or equal to 3 μm. In addition, the thickness of the adhesive layer 32 is preferably less than or equal to 15 μm.

The adhesive layer 32 preferably has pressure-sensitive adhesive properties. The pressure-sensitive adhesive properties referred to herein is a type of joining and mean properties in which it is possible to join by only adding a pressure at normal temperature for a short period of time without using water, a solvent, heat, and the like.

When using the adhesive layer 32 having such pressure-sensitive adhesive properties, it is possible to sufficiently secure the adhesive strength between the base material 2 and the film material 31. The glass transition temperature of the adhesive layer 32 is preferable, for example, −100° C. to 25° C. When the glass transition temperature is within the above-described temperature range, it is possible to obtain the adhesive layer 32 which has pressure-sensitive adhesive properties and is excellent in flexibility as well. The glass transition temperature of the adhesive layer 32 is preferably lower than or equal to 10° C., more preferably lower than or equal to 0° C., and still more preferably lower than or equal to −10° C. In addition, the glass transition temperature of the adhesive layer 32 is preferably higher than or equal to −80° C., more preferably higher than or equal to −60° C., and still more preferably higher than or equal to −40° C.

The adhesive layer 32 can be produced, for example, using a resin composition for forming an adhesive layer. Resins contained in the resin composition for forming an adhesive layer is not particularly limited, and examples thereof include a (meth)acrylic resin, a silicone-based resin, a polyester-based resin, a polyvinyl acetate-based resin, a polyvinyl ether-based resin, and a urethane-based resin (adhesive). Among them, the resin composition for forming an adhesive layer preferably contains a (meth)acrylic resin from the viewpoint of heat resistance, availability, and raw material cost.

The same (meth)acrylic resin as the (meth)acrylic resin contained in the above-described resin composition for forming a base material or the (meth)acrylic resin contained in the above-described resin composition for forming a film material can be used.

The resin composition for forming an adhesive layer may further contain additives such as a pigment, a dye, an oxidation inhibitor, an antistatic agent, a flame retardant and a cross-linking agent in addition to the above-described resin components. In addition, other components may be mixed with the resin composition for forming an adhesive layer as necessary. In addition, the resin composition for forming an adhesive layer may further contain a solvent to be used in a liquid state. Examples of the solvent include an ester-based solvent such as ethyl acetate; an aromatic solvent such as toluene; ketone-based solvents such as xylene, acetone, or methyl ethyl ketone; alcohol-based solvents such as methanol, ethanol, or isopropyl alcohol; and an aliphatic solvent such as hexane.

The adhesive layer 32 may be formed using the above-described resin composition for forming an adhesive layer. In addition, the adhesive layer may be formed using a commercially available adhesive.

In the flow channel device 1 of the present embodiment, the difference (θ1−θ2) between a contact angle (θ1) of a portion facing the groove 23 in the coating material 3 with respect to pure water and a contact angle (θ2) of the groove 23 provided in the base material 2 with respect to pure water is −30° to 30°.

The “portion facing the groove 23 in the coating material 3” in the present embodiment is the adhesive layer 32.

When the difference (θ1−θ2) between the contact angles is less than −30°, the wettability of the adhesive layer 32 becomes excessively higher than that of the base material 2, and therefore, the flow of a solution to an interface of the base material 2 becomes worse. Thus, the possibility that air bubbles may be generated on the base material 2 side is increased. In contrast, when the difference (θ1−θ2) between the contact angles exceeds 30°, the wettability of the base material 2 becomes excessively higher than that of the adhesive layer 32, and therefore, the flow of a solution to an interface of the adhesive layer 32 becomes worse. Thus, the possibility that air bubbles may be generated on the adhesive layer 32 side is increased. For this reason, in order to avoid the generation of air bubbles, the difference (θ1−θ2) between the contact angle (θ1) of the portion facing the groove 23 in the adhesive layer 32 with respect to pure water and the contact angle (θ2) of the groove portion of the base material 2 with respect to pure water is set to −30° to 30°.

From the viewpoint of more effectively avoiding generation of air bubbles on the base material 2 side, the difference (θ1−θ2) between the contact angles is preferably greater than or equal to −20° and more preferably greater than or equal to −10°.

In addition, from the viewpoint of more effectively avoiding generation of air bubbles on the adhesive layer 32 side, the difference (θ1−θ2) between the contact angles is preferably less than or equal to 20° and more preferably less than or equal to 100.

Adjustment of the difference (θ1−θ2) between the contact angles can be performed by adjusting at least one of the contact angle (θ1) on the adhesive layer 32 side and the contact angle (θ2) on the base material 2 side. The adjustment of the contact angles (θ1, 02) regarding the adhesive layer 32 side can be performed, for example, by selecting (including selection of the presence or absence of additives and the types of additives) the material constituting the portion facing the groove 23 in the adhesive layer 32 or through a surface treatment performed on the portion facing the groove 23 in the adhesive layer 32. The adjustment of the contact angles can also be performed by combining both the above-described selection of the material and the surface treatment. The adjustment of the contact angles regarding the base material 2 side can be performed by selecting (including selection of the presence or absence of additives and the types of additives) the material constituting the base material 2 or through a surface treatment performed on the portion of the groove 23. The adjustment of the contact angles can also be performed by combining both the above-described selection of the material and the surface treatment.

### Second Embodiment

As shown in FIG. 3, a coating material 3 integrated with a base material 2 may be a fluid-impermeable film material 31 of a single layer. That is, the coating material 3 may be consisting of only the film material 31. In this second embodiment, a flow channel device 1 is constituted such that the base material 2 and the film material 31 are directly integrated without interposing an adhesive layer 32, unlike the above-described first embodiment.

The thickness of the film material 31 or a resin composition for forming a film material for producing the film material 31 may be the same as that in the coating material 3 of the first embodiment. In a case where the coating material 3 consists of the film material 31 of a single layer and the base material 2 and the film material 31 are directly integrated as in the present embodiment, it is preferable that the resin composition for forming a film material is the same as a resin composition for forming a base material or the type of the resin composition for forming a film material 31 is the same as that of the resin composition for forming a base material. That is, the base material 2 and the film material 31 are preferably formed of the same or similar material. Accordingly, the inner surface of the entirety of a flow channel 28 can be formed of substantially the same material in the flow channel device 1 to be obtained and it is possible to easily uniformize the flow of a fluid within the flow channel 28.

Furthermore, the constituent materials of the base material 2, the film material 31, and the adhesive layer 32 may be selected on conditions whether the materials have high transparency, generation efficiency of autofluorescence with respect to ultraviolet rays or visible rays is low, or the like, in addition to each of the above-described viewpoints.

Similarly to the above-described first embodiment, in the flow channel device 1 of the present embodiment, the difference (θ1−θ2) between a contact angle (θ1) of a portion facing a groove 23 in the coating material 3 with respect to pure water and a contact angle (θ2) of the groove portion of the base material 2 with respect to pure water is adjusted to be −30° to 30°.

The “portion facing the groove 23 in the coating material 3” in the present embodiment is the film material 31.

In the flow channel device 1 of the present embodiment, by adjusting the difference (θ1−θ2) between the contact angle (θ1) of the portion facing the groove 23 in film material 31 with respect to pure water and the contact angle (θ2) of the groove portion of the base material 2 with respect to pure water to be −30° to 30°, it is possible to obtain the same effect as that of the flow channel device 1 of the above-described first embodiment.

(Method for Producing Flow Channel Device)

The method for producing the flow channel device 1 includes a base material preparation step, a coating material preparation step, and an integration step. The base material preparation step and the coating material preparation step may be performed in random order. The integration step is performed after both the base material preparation step and the coating material preparation step are completed. In addition, the method for producing the flow channel device 1 may further include a surface treatment step (at least one of a first surface treatment step and a second surface treatment step to be described below) as necessary.

The base material preparation step is a step of preparing the base material 2 having the groove 23 on a principal surface. In the base material preparation step, the groove 23 is formed, for example, on a commercially available plate-shaped resin material or a plate-shaped parent material formed of a resin composition for forming a base material through methods such as cutting, etching, photolithography, laser ablation, and hot embossing. In addition, the base material 2 in which the groove 23 is formed may be directly produced through a method such as injection molding using a predetermined mold and the resin composition for forming a base material. In the base material preparation step, a first through-hole 21, a second through-hole 22, and a concavity 24 are concurrently formed in the same manner as that of the groove 23.

After the base material preparation step, a surface treatment step (first surface treatment step) of subjecting the base material 2 having the groove 23 to a surface treatment may be performed before the integration step. The surface treatment is performed on the principal surface of the base material 2 in which the groove 23 is formed. Examples of the surface treatment include a plasma treatment, a corona discharge treatment, an excimer treatment, and a surface coating treatment using a hydrophilic polymer. Examples of the hydrophilic polymer include polyethylene glycol (PEG), EVAL, (EVOH), POVAL (PVOH), or a hydrophilic polymer having a polymer, which includes a phosphorylcholine group, as a component. It is possible to improve the flow of a fluid by making the inner surface (both side surfaces and bottom surface) of the flow channel 28 hydrophilic by performing surface treatments thereof. In addition, it is possible to adjust at least wettability or electrostatic properties of the inner surface of the flow channel 28. Accordingly, in a case of, for example, using the flow channel device 1 as a microelectrophoresis device, it is possible to easily control electroosmotic flow (EOF). It is possible to adjust the contact angle (θ2) of the groove 23 with respect to pure water by subjecting both side surfaces and the bottom surface of the groove 23 formed in the base material 2 to a surface treatment. By performing the surface treatment in this manner, even in a case where the base material 2 is formed of a material having a large or small contact angle with respect to pure water, it is possible to form the base material 2 suitable for the flow channel device 1.

The coating material preparation step is a step of preparing the coating material 3. In the coating material preparation step in the first embodiment, the coating material 3 formed of a laminate of the film material 31 and the adhesive layer 32 is prepared by forming the adhesive layer 32 on a single surface of the film material 31. In this case, the thin film-like film material 31 is formed, for example, using a resin composition for forming a film material and a principal surface of the film material 31 is coated with a liquid-like resin composition for forming an adhesive layer which contains a solvent, through a method such as roll coating or gravure coating. Thereafter, it is possible to obtain the coating material 3 formed of the laminate of the film material 31 and the adhesive layer 32 after performing warm-air drying. After the drying, aging may be performed by allowing the coating material to stand for several days in order to allow a cross-linking reaction to proceed. In addition, in a case of forming the adhesive layer 32, it is preferable to select the material forming the adhesive layer 32 in consideration of the difference (θ1−θ2) between the contact angle (θ1) with respect to pure water and the contact angle (θ2) of the groove portion of the base material 2 with respect to pure water.

In the coating material preparation step in the second embodiment, the coating material 3 formed of the film material 31 of the single layer is prepared by forming the thin film-like film material 31, for example, using a resin composition for forming a film material.

In a case of preparing the film material 31 of a single layer, it is preferable to select the material forming the film material 31 in consideration of the difference (θ1−θ2) between the contact angle (θ1) with respect to pure water and the contact angle (θ2) of the groove portion of the base material 2 with respect to pure water.

After the coating material preparation step, a surface treatment step (second surface treatment step) of subjecting the coating material 3 to a surface treatment may be performed before the integration step. The surface treatment is performed on one principal surface (a portion overlapping with the groove 23 in a plan view which is the surface of the adhesive layer 32 in the first embodiment and the surface of the film material 31 in the second embodiment) of the coating material 3. By performing the surface treatment, it is possible to adjust the contact angle (θ1) of the portion facing the groove 23 in the coating material 3 with respect to pure water. By performing the surface treatment in this manner, even in a case where the portion facing the groove 23 in the coating material 3 is formed of a material having a large or small contact angle with respect to pure water, it is possible to form the coating material 3 suitable for the flow channel device 1. It is possible to similarly apply the above-described each of the methods as the surface treatment. It is possible to improve the flow of a fluid by making the inner surface (ceiling surface) of the flow channel 28 hydrophilic by performing surface treatment in this manner. In addition, it is possible to adjust at least the wettability of the portion facing the groove 23 in the coating material 3 (a portion overlapping with the groove 23 in a plan view out of the adhesive layer 32 in the first embodiment and the film material 31 in the second embodiment) of the coating material 3.

The integration step is a step of integrating the coating material 3 and the base material 2 having the groove 23 by overlapping them with each other.

In the first embodiment, the base material 2 and the coating material 3 are bonded to each other by overlapping with each other such that the adhesive layer 32 covers the groove 23 by making the one principal surface of the base material 2 and the adhesive layer 32 of the coating material 3 face to each other. In this case, it is possible to bond the base material 2 and the coating material 3 to each other under a normal temperature condition (for example, a normal temperature condition of 15° C. to 40° C. and preferably 20° C. to 30° C.) without using heating means such as a heater. At this time, the laminate of the base material 2 and the coating material 3 may be obtained by bonding the base material and the coating material to each other by applying pressure thereto at a pressure of 0.3 MPa to 4 MPa and preferably 0.5 MPa to 2 MPa. Under such a temperature condition and a pressure condition, it is possible to suppress deformation of the shape of a flow channel and to improve the production efficiency.

In the second embodiment, thermal pressure bonding is performed by making the base material 2 and the coating material 3 overlap each other such that film material 31 covers the groove 23 by making the one principal surface of the base material 2 and the coating material 3 formed of the film material 31 face each other. In this case, it is possible to subject the base material 2 and the film material 31 to thermal pressure bonding by applying pressure thereto, for example, at 1 MPa to 4 MPa and preferably 1.5 MPa to 2.5 MPa in a state where heat is added thereto at 50° C. to 200° C. and preferably 70° C. to 160° C. using heating means such as a heater. In addition, the base material 2 and the film material 31 may be integrated through other methods, for example, solvent bonding or ultrasound bonding other than the thermal pressure bonding.

The flow channel device 1 can be used, for example, as a microanalysis device or a microreaction device. In addition, the flow channel device 1 can also be used as a micro-treatment device.

The microanalysis device is a device for detecting or quantitatively determining a specific substance contained in the liquid sample using the liquid surface as a specimen solution. Examples of the liquid sample include sweat, blood, saliva, urine, and a living body-derived fluid such as tissue extract. Examples of the specific substance include in vivo molecules such as DNA, RNA, proteins, sugars, and lipids which can be biomarkers in various disease or health conditions. Specifically, the flow channel device 1 can be used, for example, as an integrated type DNA analysis device, a microelectrophoresis device, and a micro-liquid chromatography device.

The microreaction device is a device (microreactor) for performing a chemical reaction or a biochemical reaction using various substances as starting materials. The micro-treatment device is a device for performing various treatments such as separation, mixing, extraction, membrane separation, and dialysis of a liquid sample using the liquid sample as an object to be treated.

All of the functions as the method, the micro-treatment device, the microreaction device, and the microanalysis device may be provided in the flow channel device 1 to perform processes, for example, a pretreatment, a reaction, separation, purification, detection, and quantitative determination of a liquid sample in this order in a single flow channel device 1.

The flow channel device 1 shown in FIG. 1 is an example of the microanalysis device. In this device, the first through-hole 21, the second through-hole 22, the groove 23, and the concavity 24 which are formed in the base material 2 respectively function as an inlet port 26, an outlet port 27, the flow channel 28, and a detection unit 29. That is, a liquid sample as a specimen is introduced through the inlet port 26 and flows into the flow channel 28 toward the outlet port 27. A compound which develops color through reacting or interacting with a specific substance in the liquid sample is immobilized to the detection unit 29 provided on the way of the flow channel 28. Therefore, it is possible to quantitatively analyze the specific substance by detecting the emission intensity in the detection unit 29 using an optical system detector.

According to the flow channel device 1 of the present invention, it is possible to effectively suppress generation of air bubbles within the flow channel 28. Accordingly, it is possible to secure favorable reactivity in a case of using the flow channel device 1, for example, as the microreaction device or to secure high detection accuracy in a case of using the flow channel device 1, for example, as a microanalysis device.

Hereinafter, the flow channel device 1 of the present embodiment will be described in more detail while showing a plurality of test examples. However, the scope of the present invention is not limited by the following test examples.

### Example 1

A flow channel device 1 was produced according to the following procedure. First, an acrylic substrate having a size of 50 mm×50 mm×1.5 mm in thickness was produced using an acrylic resin (DELPET 70NH manufactured by Asahi Kasei Corporation) and a plurality of grooves 23 having a width of 100 μm and a depth of 30 μm were formed using a cutting machine to use this substrate as a base material 2. Pure water was added dropwise to this base material 2 and the contact angle was measured using an automatic contact angle meter (product number: CA-V series manufactured by Kyowa Interface Science Co., LTD.). The measured contact angle was 70°.

Next, an acrylic film was obtained such that a resin containing 99.0 parts by weight of methyl methacrylate and 1.0 part by weight of butyl acrylate was molded into a film form having a thickness of 125 μm.

A principal surface of this acrylic film was coated with an adhesive (6LQ-002 manufactured by TAISEI FINE CHEMICAL CO., LTD.) and the coated adhesive was dried in an oven. Subsequently, the dried adhesive was allowed to stand for 1 week in an environment at 24° C. for aging and a coating material 3 formed of a laminate of the film material 31 and the adhesive layer 32 was obtained. Pure water was added dropwise to the surface on the adhesive layer 32 side of this coating material 3 and the contact angle was measured using the above-described automatic contact angle meter. The measured contact angle was 96°.

Thereafter, the surface of the base material 2 on which the grooves 23 were formed and the exposed surface of the adhesive layer 32 of the coating material 3 are laminated such that both the surfaces face each other. The surfaces were integrated through bonding by applying pressure thereto for 3 seconds at 1 MPa at 25° C. to obtain a multichannel flow channel device 1.

### Example 2

A multichannel flow channel device 1 in which a base material described in Example 1 and a coating material excluding an adhesive were integrated by applying pressure thereto for 40 seconds at 4 MPa at 77° C. was obtained using an acrylic film formed of a resin containing 90.0 parts by weight of methyl methacrylate and 10.0 parts by weight of butyl acrylate. The contact angle of pure water with respect to the base material 2 was 70° and the contact angle of pure water with respect to the film material 31 was 85°.

### Example 3

A flow channel device 1 was obtained in the same manner as in Example 2 except that the acrylic film was changed to an acrylic film formed of a resin containing 99.5 parts by weight of methyl methacrylate and 0.5 parts by weight of butyl acrylate. The contact angle of pure water with respect to the base material 2 was 70° and the contact angle of pure water with respect to the film material 31 was 66°.

### Example 4

A flow channel device 1 was obtained in the same manner as in Example 1 except that the adhesive was changed to another adhesive (5296 manufactured by Toyochem Co., Ltd.) and an excimer treatment was performed for 120 seconds after aging. The contact angle of pure water with respect to the base material 2 was 70° and the contact angle of pure water with respect to the adhesive layer 32 was 69°.

### Example 5

A flow channel device 1 was obtained in the same manner as in Example 1 except that the adhesive was changed to another adhesive (5296 manufactured by Toyochem Co., Ltd.) and 2.5 wt % of a hydrophilizing agent (1SX-1096A manufactured by TAISEI FINE CHEMICAL CO., LTD.) was added to 100 wt % of the adhesive. The contact angle of pure water with respect to the base material 2 was 70° and the contact angle of pure water with respect to the adhesive layer 32 was 60°.

### Example 6

A flow channel device was obtained in the same manner as in Example 5 except that 3.5 wt % of a hydrophilizing agent (1SX-1096A manufactured by TAISEI FINE CHEMICAL CO., LTD.) was added to 100 wt % of an adhesive. The contact angle of pure water with respect to the base material 2 was 70° and the contact angle of pure water with respect to the adhesive layer 32 was 41°.

### Example 7

A flow channel device was obtained in the same manner as in Example 1 except that the base material was changed to a polycarbonate-based resin (LUPILON H-4000 manufactured by Mitsubishi Engineering-Plastics Corporation). The contact angle of pure water with respect to the base material 2 was 85° and the contact angle of pure water with respect to the adhesive layer 32 was 96°.

### Comparative Example 1

A flow channel device was obtained in the same manner as in Example 1 except that the adhesive was changed to another adhesive (5296 manufactured by Toyochem Co., Ltd.). The contact angle of pure water with respect to the base material 2 was 70° and the contact angle of pure water with respect to the adhesive layer 32 was 104°.

### Comparative Example 2

A flow channel device was obtained in the same manner as in Example 1 except that the adhesive was changed to another adhesive (5296 manufactured by Toyochem Co., Ltd.) and 5.0 wt % of a hydrophilizing agent (1SX-1096A manufactured by TAISEI FINE CHEMICAL CO., LTD.) was added to 100 wt % of the adhesive. The contact angle of pure water with respect to the base material 2 was 70° and the contact angle of pure water with respect to the adhesive layer 32 was 11°.

[Evaluation 1 (Air Bubble Generation Evaluation)]

A flow channel of the flow channel device 1 obtained in each of the test examples was filled with pure water by a capillary phenomenon and the presence or absence of generation of air bubbles in a flow channel was observed using an optical microscope. If the generation of air bubbles with a size of larger than or equal to 50 μm was not checked in any channel, the flow channel device was evaluated as “good”. If the generation of air bubbles with the above-described size was checked in any channel, the device was evaluated as “worse”.

[Evaluation 2 (Flow Channel Shape Evaluation)]

The shape of each of the flow channels of the flow channel devices obtained in each of the Examples and Comparative Examples was measured using a laser displacement meter. In a case where the height of a flow channel of a flow channel device was higher than or equal to 28.5 μm and lower than 30.0 μm, the flow channel device was evaluated as “excellent” and in a case where the height of a flow channel of a flow channel device was higher than or equal to 24.0 μm and lower than 28.5 μm, the flow channel device was evaluated as “good” (slightly deformed, but can be used as a product). These results are shown below.

TABLE 1

| | Coating material | | |
|---|---|---|---|
| | Film material | Adhesive layer | Base material |
| Example 1 | MMA99 + BA1 | 6LQ-002 | 70NH |
| Example 2 | MMA90 + BA10 | — | 70NH |
| Example 3 | MMA99.5 + BA0.5 | — | 70NH |
| Example 4 | MMA99 + BA1 | 5296 + Excimer | 70NH |
| | | treatment | |
| | | 5296 + 2.5% | |
| Example 5 | MMA99 + BA1 | hydrophilizing | 70NH |
| | | agent | |
| | | 5296 + 3.5% | |
| Example 6 | MMA99 + BA1 | hydrophilizing | 70NH |
| | | agent | |
| Example 7 | MMA99 + BA1 | 6LQ-002 | H-4000 |
| Comparative | MMA99 + BA1 | 5296 | 70NH |
| Example 1 | | | |
| Comparative | MMA99 + BA1 | 5296 + 5.0% | 70NH |
| Example 2 | | hydrophilizing | |
| | | agent | |

TABLE 2

| | θ1 | θ2 | θ1-θ2 | Evaluation 1 | Evaluation 2 |
|---|---|---|---|---|---|
| Example 1 | 96° | 70° | 26° | good | excellent |
| Example 2 | 85° | 70° | 15° | good | good |
| Example 3 | 66° | 70° | ~4° | good | good |
| Example 4 | 69° | 70° | ~1° | good | excellent |
| Example 5 | 60° | 70° | ~10° | good | excellent |
| Example 6 | 41° | 70° | −29° | good | excellent |
| Example 7 | 96° | 85° | 11° | good | excellent |
| Comparative | 104° | 70° | 34° | worse | excellent |
| Example 1 | | | | | |
| Comparative | 11° | 70° | ~59° | worse | excellent |
| Example 2 | | | | | |

From the above-described results, it was confirmed that it was possible to effectively suppress the generation of air bubbles within a micro-flow channel by setting the difference (θ1−θ2) between the contact angle (θ1) of a portion facing the groove 23 in the coating material 3 with respect to pure water and the contact angle (θ2) of the groove portion of the base material 2 with respect to pure water to be −30° to 30°. In addition, it was confirmed that there was almost no deformation in the shape of the flow channel if the difference (θ1−θ2) between the contact angles is within the range of −30° to 30°. It was also confirmed that even if there was deformation, there was no problem as a product and it was possible to suppress the deformation to a usable degree.

The embodiments disclosed in the present specification are examples in all respects. However, the configuration disclosed in the above-described embodiments can be appropriately modified within the scope not departing from the gist of the present disclosure.

### BRIEF DESCRIPTION OF THE REFERENCE SYMBOLS

1: FLOW CHANNEL DEVICE
2: BASE MATERIAL
3: COATING MATERIAL
23: GROOVE
31: FILM MATERIAL
32: ADHESIVE LAYER

1. A flow channel device comprising:
a base material having a groove; and
a coating material which is integrated with the base material so as to cover the groove,
wherein the difference (θ1−θ2) between a contact angle (θ1) of a portion facing the groove in the coating material with respect to pure water and a contact angle (θ2) of the groove portion of the base material with respect to the pure water is −30° to 30°.

2. The flow channel device according to claim 1,
wherein the coating material includes a fluid-impermeable film material and an adhesive layer which is laminated on the fluid-impermeable film material, and the base material and the fluid-impermeable film material are integrated by the adhesive layer.

3. The flow channel device according to claim 2,
wherein the adhesive layer has pressure-sensitive adhesive properties.

4. The flow channel device according to claim 2,
wherein the adhesive layer contains a (meth)acrylic resin.

5. The flow channel device according to claim 3,
wherein the adhesive layer contains a (meth)acrylic resin.

6. The flow channel device according to claim 1,
wherein the coating material is formed of a fluid-impermeable film material of a single layer, and the base material and the fluid-impermeable film material are integrated.

7. The flow channel device according to claim 1,
wherein the base material contains at least one selected from the group consisting of a (meth)acrylic-based resin, a styrene-based resin, a polycarbonate-based resin, and a polyolefin-based resin.
